(19) United States
(12) Patent Application Publication
(10) Pub. No.: US 2016/0295544 A1
(43) Pub. Date: Oct. 6, 2016

(54) ENHANCED CLOUD SIM

(71) Applicant: GLOBETOUCH, INC., Santa Clara, CA (US)

(72) Inventors: John Yue JIANG, Santa Clara, CA (US); Subrata DUTIA, Santa Clara, CA (US); Sandeep SUDARSHAN, Santa Clara, CA (US); Sacchidanand DUBEY, Santa Clara, CA (US)

(21) Appl. No.: 15/085,689

(22) Filed: Mar. 30, 2016

Related U.S. Application Data
(60) Provisional application No. 62/140,953, filed on Mar. 31, 2015.

(51) Int. Cl. H04W 60/04; H04L 5/00; H04W 8/06

(52) U.S. Cl. CPC H04W 60/04; H04W 8/06; H04L 5/0053

(57) ABSTRACT

The present invention provides a method and system for mobile communication where upon detecting a change in registration of a SIM device at a visited operator (VPMN), the SIM device's IMSI profile is switched to one of a HPMN IMSI profile or local IMSI profile of a hub operator. The hub operator is selected from a cloudSIM hub ecosystem, depending on the location of the SIM device and quality and regulatory requirements of the service associated with the SIM device. The cloudSIM hub allocates dynamic IMSI with either a partial IMSI profile or a full IMSI profile based on SIM device requirements. The full profile has security key information of HPMN or the VPMN, and the SIM device requirement can be from either a softSIM, an eSIM or a standard SIM.

### RELATED APPLICATIONS

This application claims priority from U.S. Provisional Patent Application 62/140,953 entitled “CloudSIM Dynamic IMSI Allocation”, filed on Mar. 31, 2015. The aforementioned patent applications are incorporated herein by this reference in its entirety.

### TECHNICAL REFERENCES

GSM 902 on MAP specification
Digital cellular telecommunications system (Phase 2+)

### Mobile Application Part (MAP) Specification

(3GPP TS 09.02 version 7.9.0 Release 1998)

### GSM 340 on SMS

Digital cellular telecommunications system (Phase 2+)
Technical realization of the Short Message Service (SMS)
(GSM 03.40 version 7.4.0 Release 1998)

### GSM 378 on CAMEL,

### GSM 978 on CAMEL Application Protocol,

### GSM 379 on CAMEL Support of Optimal Routing (SOR),

### GSM 318 on CAMEL Basic Call Handling

### 3GPP TS 29.060 on GTP

3GPP TS 23.048 on IMSI/Profile download to Applet
ITU-T Recommendation Q.1214 (1995), Distributed functional plane for intelligent network CS-1,
ITU-T Recommendation Q.1218 (1995), Interface Recommendation for intelligent network CS-1,
ITU-T Recommendation Q.762 (1999), Signaling system No. 7—ISDN user part general functions of messages and signals,
ITU-T Recommendation Q.763 (1999), Signaling system No. 7—ISDN user part formats and codes,
ITU-T Recommendation Q.764 (1999), Signaling system No. 7—ISDN user part signaling procedures,
ITU-T Recommendation Q.765 (1998), Signaling system No. 7—Application transport mechanism,
ITU-T Recommendation Q.766 (1993), Performance objectives in the integrated services digital network application,
ITU-T Recommendation Q.769.1 (1999), Signaling system No. 7—ISDN user part enhancements for the support of Number Portability

### FIELD OF THE INVENTION

The present invention generally relates to mobile communication. More specifically, the invention relates to handling mobile communication while roaming.

### BACKGROUND OF THE INVENTION

Roaming traffic contributes a significant percentage of an operator's revenue and even a better percentage of the operator's margin. With increasing competition and regulatory control, operators are being more pressured to increase their roaming revenue. Over the last few years, revenues to the network operators from home subscribers have consistently declined due to increased competition and resulting pricing pressures. On the other hand, revenues from roamers have consistently grown in the same period due to increased mobile penetration in local markets and an increase in travel.

As the global mobile roaming market business model is evolving, the industry understands the strategic importance of roaming to operator's revenues and profit margins and is adapting various newly proposed regulations. The operators understand that they must develop strategies for driving the number of roamers and roaming usage, while lowering tariff rates.

Amongst the roaming business, the average margins on inbound roaming revenue is around 80% and the average margins on outbound roaming revenue is around 20%. The key challenge lying before the operators is to maximize the outbound roaming revenues. While analyzing the outbound roaming revenues, it should be noted that on an average 40% of the outbound roaming revenues are contributed from Mobile Originated (MO) calls made by outbound roamers. Of these MO calls, almost 70% calls are back home and 10% are to other markets outside the current roaming destination of the subscribers. The revenue earned by the operator from these calls is minimal considering the revenue distribution between the current roaming network of the roamers and the destination network to where the call is made.

The roaming charges levied to a roamer for the outgoing calls made also constitute Inter Operator Tariffs and retail markups. The operators are increasingly coming under price pressure to offer better retail rates compared to wholesale tariff. The IOTs carry about 80% margin today whereas retail roaming charges carry only 20% margin. While the operators rely heavily on IOT discounting while setting up roaming agreements to maximize their roaming margins, the exception to the rule is outgoing international calls to other networks, the international outgoing calls continue to be expensive.

The key drivers constituting outbound roaming revenue are hence the Inter Operator Tariff, Termination Rates and Retail Markup. The operator can leverage the retail markup by selecting a “preferred partner” network that offers lesser IOT and lesser termination fees. There could also be an ecosystem of such preferred partner networks who offer each other discounted tariffs.

Due to the increasing market of smartphones and new services like M2M, there is an explosive growth of data traffic as more and more users use data connections while on roaming. This data roaming revenue thus becomes strategic focus point for operators, and they employ various techniques/solution to increase their share of data roaming revenue.

Various systems exist in the prior art that provide ways to provision preferred network's IMSI while roaming. However, these systems require the operator to provision dual IMSI or multi-IMSI SIM cards, and this becomes a logistical challenge for the operator. Also, these solutions are unable to have segregate network traffic by usage from client operator or local subscriber due to IMSI being used.

In accordance with the foregoing, there is a need in the art of a system, a method, for creating a solution that gives an operator the ways to leverage the ecosystem of preferred partner networks to enable a subscriber use a preferred network's IMSI while roaming, without the need for provisioning a special IMSI and also going beyond standard plug-in SIM to a soft SIM device or an embedded SIM device.

### SUMMARY

The present invention is directed towards method and system for mobile communication where upon detecting a change in registration of a SIM device at a visited operator (VPMN), the SIM device's IMSI profile is switched to HPMN IMSI profile or one of the local IMSI profiles of a hub operator. The hub operator is selected from a cloudSIM hub ecosystem, depending on the location of the SIM device and quality and regulatory requirements of the service associated with the SIM device. The cloudSIM hub allocates dynamic IMSI with either a partial IMSI profile or a full IMSI profile based on SIM device requirements. The full profile has security key information of HPMN or the VPMN, and the SIM device requirement can be from either a softSIM, an eSIM or a standard SIM.

The system and method of the present invention, in its various embodiments provide the cloudSIM ecosystem that has multiple hub partner networks that subscribe to the cloudSIM service. The service offering that leverages partnership with leading signaling and voice service providers around the world, to re-route the call via a cloudSIM hub that is deployed in the carrier cloud. The SIM device's IMSI profile is switched with either HPMN IMSI profile or local IMSI profile of a hub operator depending on the location of the SIM device and quality and regulator requirements. The user experience for the roaming subscriber is not affected in any way, and he continues to enjoy normal roaming service while traveling.

The present invention provides a cloudSIM service that is an ecosystem that leverages mobile operators to offer discounted tariff to client networks which have subscribed to the cloudSIM service and are a part of cloudSIM ecosystem. The subscribing operator doesn't need to use a multi-IMSI SIM card, rather can continue to use the existing SIM, where the invention through its various embodiments just switches the IMSI profile based on various criteria.

The system and method of the present invention, in its various embodiments using the cloudSIM hub uses STK (applet) in a standard SIM along with OTA function to handle dynamic IMSI allocation via cloudSIM DIA platform. The switching of IMSI profile intelligently selects the right network for the service without any manual intervention from the end subscriber thus making the entire roamer experience seamless.

The system and method of the present invention, in accordance with its embodiments, provides cloudSIM service for M2M connected car system where an eSIM (i.e, an embedded SIM) is factory fitted, and cloudSIM hub seamlessly allocates the right IMSI profile under regulatory nouns. The eSIM profile can be provisioned as an MNO offering connectivity to the connected car. The home routing of all traffic can be done via cloudSIM hub or MNO's home operator, depending on who is providing enterprise connectivity.

### BRIEF DESCRIPTION OF DRAWINGS

In the drawings, the same or similar reference numbers identify similar elements or acts.

FIG. 1 illustrates a system for implementing cloudSIM service, in accordance with a first embodiment of the present invention;

FIG. 2 represents a flowchart depicting method for enabling mobile communication using the cloudSIM service, in accordance with an embodiment of the present invention; and

FIG. 3 represents a call flow depicting method for enabling mobile communication using the cloudSIM service, in accordance with an embodiment of the present invention.

### DETAILED DESCRIPTION

In the following description, for purposes of explanation, specific numbers, materials and configurations are set forth in order to provide a thorough understanding of the present invention. It will be apparent, however, to one having ordinary skill in the art that the present invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the present invention. The appearance of the phrase “in an embodiment”, in various places in the specification, does not necessarily refer to the same embodiment.

The present invention provides a system and a method for facilitating mobile communication for a subscriber of a Home Public Mobile Network (HPMN) roaming in a Visited Public Mobile Network (VPMN). In accordance with various embodiments, the present invention provides a method and system providing the subscriber a facility to use IMSI of a different operator other than his home operator's IMSI to offer better tariffs.

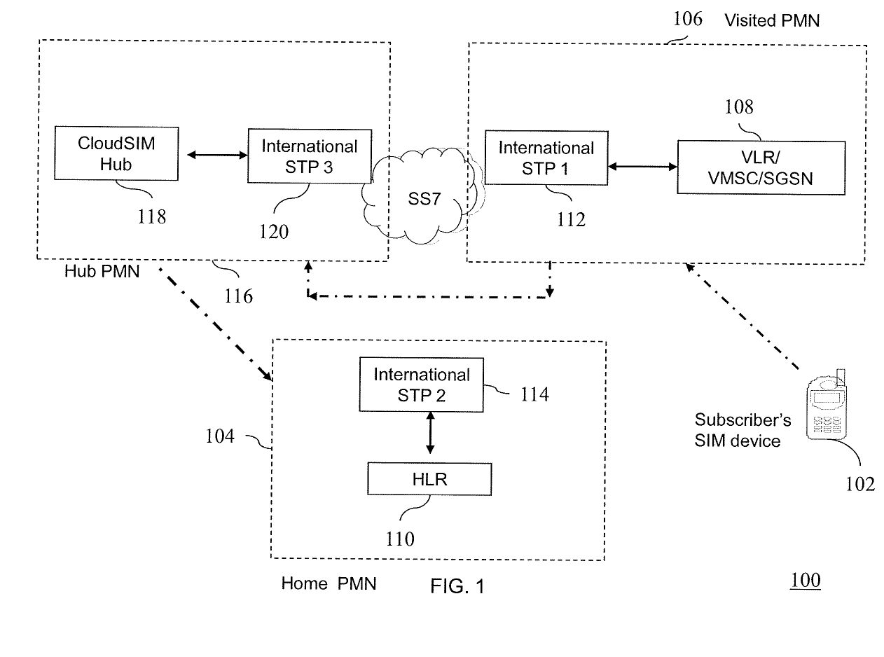

FIG. 1 illustrates a system 100 for implementing cloudSIM service, in accordance with an embodiment of the present invention. A SIM device 102 (of a subscriber) of HPMN 104 (from home country) is roaming in a VPMN 106 (from visiting country). The SIM device 102 is hereinafter interchangeably referred to subscriber 102. The SIM device 102 is connected to a VPMN VLR 108, when it is roaming outside HPMN 102. In one embodiment of the invention, VPMN VLR 108 is integrated with a VMSC in VPMN 106. Notwithstanding, both VPMN VLR and VMSC may have different logical addresses. Subscriber profile data corresponding to subscriber 102 is stored in HPMN HLR 110. The signaling corresponding to subscriber 102 is routed using an international STP 1 112 at VPMN 106 and international STP 2 114 at HPMN 104. The signaling between HPMN 104 and VPMN 106 is carried using SS7 signaling architecture 116. The signals exchanged between HPMN 104 and VPMN 106 are MAP based signals. Other network elements of HPMN 104 (e.g., MSC/VLR) communicate with various other network elements of VPMN 106 (e.g., HLR, VLR etc.) via the SS7 link. It will also be apparent to a person skilled in the art that various components of HPMN 104 communicate with VPMN 106 using various signaling techniques including, but not limited to, SS7, SIP, IP, ISUP etc.

The HPMN 104 subscribes to the cloudSIM service as client operator to enable dynamic IMSI allocation to its subscriber's SIM device 102. The visited operator in VPMN 106 is the current location of the subscriber. The dynamic IMSI profiles that are provisioned on SIM device belong to a hub PMN that is a part of cloudSIM ecosystem. In this embodiment, hub PMN 116 provides its IMSI to subscriber's SIM. The hub PMN 116 includes a cloudSIM hub 118 that interfaces with international STP 3 120 to manage the signaling across networks. The hub operator is either an MVNO, an MNO having its own set of IMSIs.

It will be apparent to a person skilled in the art that cloudSIM hub 118 can be present either on-net hub PMN 116 or off-net hub PMN 116. In other words, the cloudSIM hub 118 can be deployed in hub PMN 116 or at a central location that is serving multiple hub PMNs that are a part of cloudSIM ecosystem.

With more and more client operators and ecosystem partners joining the cloudSIM ecosystem, it is not feasible to get everybody connected to once central cloudSIM Hub. In other embodiments, cloudSIM implements multi-hub architecture where regional hubs are used to connect to different clients participating in the ecosystem. The clients and ecosystem partners in each region can be connected to the regional hubs. All the regional hubs will be fully interconnected to ensure clients in one region should be served by an ecosystem partner in another region and vice versa.

The cloudSIM ecosystem service leverages Globetouch's ecosystem of cloudSIM hubs to offer special discounted tariff to the client operators who want to be a part of cloudSIM ecosystem. In accordance with various embodiments of the invention, cloudSIM hub 118 converts one or more signaling parameters of signaling associated with the hub operator's IMSI to one or more signaling parameters of the signaling associated with the client operator's IMSI. The one or more signaling parameter could include MSISDN of the subscriber. In some cases, the subscriber's MSISDN is changed while communicating with the visited operator. Other signaling parameters include MAP signaling, call signaling, subscriber's MSISDN, CAMEL/SIP/TCAP transaction, data sessions and data traffic.

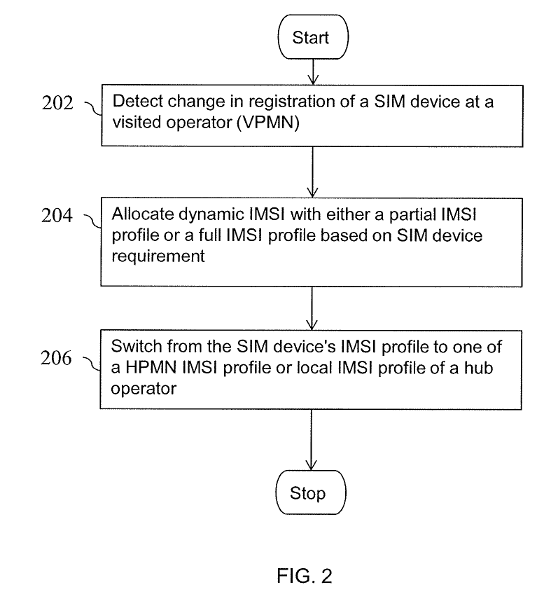

FIG. 2 represents a flowchart depicting method for enabling mobile communication using cloudSIM service, in accordance with an embodiment of the present invention. At step 202, cloudSIM hub 118 detects a change subscriber's SIM device 102 at the VPMN 106. Subsequently, at step 204, cloudSIM hub 118's DIA dynamically allocates IMSI with either a partial IMSI profile or a full IMSI profile based on SIM device 102's requirement. The full IMSI profile has security key information of HPMN 104 or VPMN 106, and the SIM device 102 can be either a softSIM, an eSIM or a standard plugin-in SIM. Finally at step 206, cloudSIM hub 118 switches from SIM device 102's IMSI to either HPMN IMSI profile or local IMSI profile of a hub operator, where the hub operator is selected from cloudSIM hub 118's ecosystem depending on the location of SIM device 102 and quality and regulatory requirements of the service associated with SIM device 102. In accordance with one embodiment of the present invention, the hub operator is hub PMN 116 that is a member of CloudSIM ecosystem.

In accordance with another embodiment of the present invention, the hub operator is selected based on various criteria like wholesale tariff agreed in visited country, type of subscriber, devices being services, pre-paid or postpaid plan, full service or data service only, or cost or QoS ranking of network in visited country.

In accordance with various other embodiments of the present invention, cloudSIM hub 118 uses a SIM STK in a standard SIM card along with OTA function to handle dynamic IMSI allocation. In another embodiment of the present invention, cloudSIM hub 118 uses a DIA from Globetouch to perform the dynamic IMSI allocation. The

In accordance with an embodiment of the present invention, cloudSIM hub 118 dynamically allocates IMSI in either a push mode or a pull mode. For example, the pull mode is implemented in case SIM devices do support USSD, where USSD is used to notify cloudSIM DIA platform about current country and network of the SIM device. In push mode, when cloudSIM DIA platform gets location notification from a roaming probe instead of cloudSIM STK applet and starts dynamic IMSI allocation workflow itself. Hereinafter, cloudSIM STK applet is interchangeably referred to as applet or cloudSIM applet. The same workflow is applied for SIM devices that do not implement STK Provide Location Information (PLI) command correctly to get the details of the current network (MCC—Mobile Country Code and MNC—Mobile Network Code) where the SIM device is latched on. Likewise, for SIM devices 102 which don't support STK Refresh command, a different workflow is followed to inform the SIM device 102 about IMSI switch by issuing a SIM STK display text message to inform the user to switch off/on the SIM device. If the device does not support the proactive command Refresh, the applet can issue a Display Text command to ask the user to restart the device. The display text can be deactivated for devices without display e.g. some M2M devices.

In general the cloudSIM applet supports pull based approach i.e. once the SIM device is latched on to any network in Visited Country (either using Home IMSI or using Global Roaming IMSI) and the applet doesn't get a dynamic IMSI applicable for that location, the applet then sends USSD notification to cloudSIM DIA platform with the current location information and the DIA platform via OTA downloads a suitable dynamic IMSI for the current location.

In the applet of the present invention, it is able to disable the notification from the applet to DIA platform even if the applet gets a notification from the device about the new roaming location of the subscriber). The applet just lets the device remain latched on using current IMSI and waits for any OTA SMS from the DIA server with a new dynamic IMSI for the current location. This case is applicable for certain client operators who prefer alternative source of location trigger e.g. roaming probes due to lack of USSD support in devices or network. This is referred to as push mode operation of DIA workflow in accordance with various embodiments of the present invention.

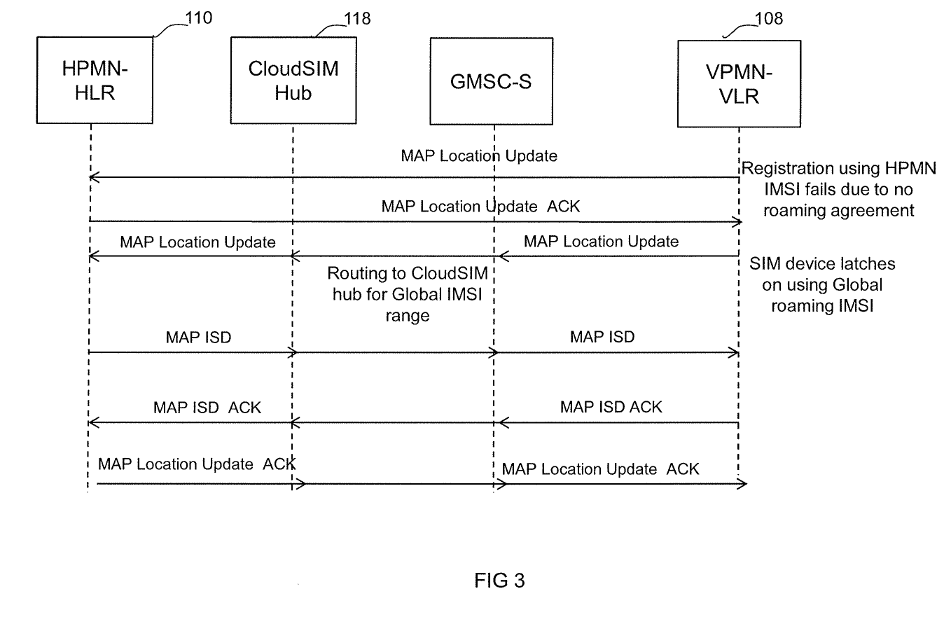

FIG. 3 represents a typical call flow for enabling registration of SIM device 102's in VPMN 104 using global IMSI that is dynamically allocated by cloudSIM hub 118, in accordance with an embodiment of the present invention. As seen in the call, the initial registration attempt from VPMN 106 fails as there is no roaming agreement. The cloudSIM hub monitors the location update message, as a global roaming IMSI provisioned from cloudSIM is routed through cloudSIM platform. In other words, cloudSIM hub monitors the network registration of the current IMSI in SIM device to know the current roaming country and network of the SIM device. The cloudSIM hub 118 then allocates an IMSI suitable for current VPMN 106 using DIA business rule engine and downloads either full IMSI profile or partial IMSI profile from HPMN 104 or VPMN 106 using standard SIM OTA technology. Then the SIM device 102's registration is initiated at VPMN 106 using the downloaded IMSI profile.

The global roaming IMSI is an IMSI of any other network (e.g. provided by any other MNO or any roaming hub service provider) which is used for roaming in case HPMN doesn't have roaming agreement in any destination country. The global roaming IMSI is not mandatory and may or may not be present depending on the client. In case the Home Network IMSI cannot register to any network in the current visiting country of subscriber (the location status is in Limited Service) as there is no bilateral roaming agreement (or due to any other reason), the applet should detect the same and check if there is a Global Roaming IMSI present in the IMSI Slot. This IMSI is provisioned in SIM card during personalization but should be downloadable using OTA later to change the original global roaming IMSI. There can be multiple global roaming IMSI (with each global roaming IMSI applicable for a different set of countries) in the SIM card of the subscriber.

If there is a global roaming IMSI present, the applet makes that IMSI as active IMSI and force the SIM device to latch on using that global roaming IMSI. The configurable time period (e.g. 6 minutes) before the switching process to global roaming IMSI starts. This ensures that if home IMSI cannot latch on due to coverage issue of roaming partner network, it gets sufficient time to get back to coverage before the global roaming IMSI takes over.

If there are multiple global roaming IMSIs available in the IMSI slot, then each global roaming IMSI also contains the list of MCC-MNC where that global roaming IMSI will work. The applet refers to that list to select the right global roaming IMSI. However, it should be also possible to keep on the global roaming IMSIs as default global roaming IMSIs by not configuring a list of MCC-MNC so that if the current MCC-MNC doesn't appear with other global roaming IMSI, the applet can select this global roaming IMSI as default. The applet latches on to a global roaming IMSI if it doesn't get the location information of current location of subscriber. If the SIM device cannot latch on to global roaming IMSI, the applet should wait for a configurable time period (e.g. 6 minutes) before start attempting registration using home IMSI again. In case no global roaming IMSI is available, the device should stay in limited service mode till next power on cycle.

In accordance with various embodiments of the present invention, the dynamic IMSI allocation is done using either a local IMSI, or a permanent roaming IMSI, or a global roaming IMSI or a temporary roaming IMSI. The SIM device's 102 IMSI is based on location of SIM device 102, or class of the subscriber. The subscriber's IMSI is changed via a configuration file that can be changed by OTA communication. Alternatively, the subscriber's IMSI is changed by SIM STK application that communicates with network application via USSD, or SMS or any other bearer. The cloudSIM hub 118 stores IMSI and other subscription data in applet buffer via STK. Alternatively, cloudSIM hub 118 selects default IMSI from a sequence of IMSIs in preference order or random order, until one IMSI is successfully registered VPMN 106.

In accordance with another embodiment of the present invention, cloudSIM hub 118 converts one or more signaling parameters of signaling associated with the Home operator's IMSI to one or more signaling parameters of the signaling associated with SIM device's IMSI (from Hub Operator). The signaling parameters can be either MAP signaling, call signaling, subscriber's MSISDN, CAMEL/SIP/TCAP transaction, data sessions and data traffic. The hub operator is either an MVNO, an MNO, having its own set of IMSIs. The cloud SIM hub could be located either on-net the hub operator or off-net the hub operator.

CloudSIM hub 118 when allocating dynamically the IMSI with partial or full profile has various use case scenarios. In accordance with an embodiment of the present invention, when dynamic IMSI full profile (including security key, APN etc.) is based on VPMN 106, then cloudSIM hub 118 maintains billing and provisioning interface with the VPMN 106, and all signaling and data routing is done locally through VPMN 106.

In case dynamic IMSI partial profile has only IMSI based on the VPMN, then cloudSIM hub 118 handles signaling and data routing within cloudSIM ecosystem to configure the mapping of IMSI to another HPMN IMSI and redirect data to corresponding data gateway of HPMN 104. It will be apparent to a person skilled in the art that different dynamic IMSI profile might be routed or mapped to different HPMNs thru cloudSIM ecosystem.

In yet another embodiment of the present invention, when dynamic IMSI profile is partial with IMSI and Ki from a local VPMN 106 but the APN points to cloudSIM hub 118, then signaling is with VPMN 106 directly but data session is routed thru cloudSIM ecosystem to a mapped IMSI to an HPMN gateway. This allows authentication to be done at VPMN 106 but data service is at another HPMN.

In accordance with another embodiment of the present invention, the dynamic IMSI profile is partial with IMSI based on local VPMN 106 but Ki points to one home IMSI of one HPMN, and the APN points to cloudSIM hub 118 and the data service goes to another home network HPMN. In this case, the signaling routing goes thru cloudSIM hub 118 which maps the IMSI to IMSI of HPMN 104. But when data session goes through cloudSIM hub 118, the data service goes to the data gateways (and associated BSS/OCS/PCRF) of another home network. This allows authentication to be done at one HPMN but data service is at another HPMN.

The above four scenarios in accordance with various embodiments of the present invention, are explained further with help of below examples from M2M connected car ecosystem's perpective.

In an exemplary case, a car is sold in India and AirTel IMSI is provisioned as active IMSI. The subscriber profile (IMSI, Ki etc) will be provisioned in AirTel HLR. The APN for data services in the device will also from AirTel. So, all the services (Registration, data services) will be provided by AirTel India network. The CloudSIM Home Network (of Globetouch in Sweden) will only have provisioning and billing interfaces implemented with AirTel India brovisioning and billing systems to have necessary controls on the processes and have visibility of overall service. This is needed as GlobeTouch is primary connectivity provider for the connected car manufacturer (e.g. Honda). This can be another MNO network (e.g. Vodafone UK) instead of GlobeTouch if that MNO is the primary connectivity provider for the connected car manufacturer (with GlobeTouch just the technology provider).

In another use case, a car is sold in India and AirTel IMSI is provisioned as active IMSI. The difference from above scenario 1 is that the subscriber profile will not be provisioned in AirTel HLR. The subscriber profile will be provisioned either in Globetouch Sweden Network or any other MNO network (e.g. Vodafone UK) which is the Home Network for the car. The subscriber profile will have HPMN IMSI in HLR (GlobeTouch IMSI if GlobeTouch HLR being used or another MNO IMSI e.g. VF UK IMSI if the same network is the Home Network). The APN for data services in the device will also from HPMN (GlobeTouch or VF UK as applicable). So, all the signaling and data traffic will be routed via cloudSIM Hub which will do the IMSI translation (e.g. from AirTel IMSI to GlobeTouch IMSI or from AirTel IMSI to Vodafone UK IMSI) and route the signaling/data traffic to right HPMN. This scenario provides full control of the services by HPMN which is the primary connectivity provider for the connected car manufacturer (e.g. Honda).

In yet another use case, the car is sold in India and AirTel IMSI is provisioned as active IMSI. The subscriber profile (IMSI, Ki etc) will be provisioned in AirTel HLR. The difference from first scenario is that the APN for data services in the device is also from GlobeTouch or another Home MNO (e.g. Vodafone UK) as applicable instead of AirTel APN. As the subscriber profile will be in AirTel HLR, all the signaling (basically for network authentication and registration) is routed directly to AirTel HLR. However, as the APN is of GlobeTouch (or VF UK), the data traffic will come to cloudSIM Hub 118, which does the IMSI translation (e.g. from AirTel IMSI to GlobeTouch IMSI or from AirTel IMSI to Vodafone UK IMSI) and routes the data traffic to GlobeTouch (or VF UK) GGSN. This scenario allows to have control of the data traffic by HPMN which is the primary connectivity provider for the connected car manufacturer (e.g. Honda), where the local IMSI (AirTel in this case) must be used for some reason (e.g. regulation in some countries to always use a local profile for cars sold in India).

In yet another use case, a car is sold in India and AirTel IMSI is provisioned as active IMSI. However, like in second scenario, the subscriber profile is not provisioned in AirTel HLR. The subscriber profile is provisioned in other MNO network (e.g. Vodafone UK) which is the Home Network for the car. The subscriber profile will have HPMN IMSI in HLR (e.g. VF UK IMSI). However, the difference from the second use case is that the APN is not of HPMN (VF UK) but it will be for another network (in most cases in will be GlobeTouch but can be any other MNO APN also). As the subscriber profile will be in VF UK HLR, all the signaling (basically for network authentication and registration) will be routed to cloudSIM Hub, which will do the IMSI translation (e.g. from AirTel IMSI to Vodafone UK IMSI) and route the data traffic to Vodafone UK HLR. However, as the APN is of GlobeTouch, the data traffic will come to cloudSIM hub 118 which will do the IMSI translation (e.g. from AirTel IMSI to Vodafone UK IMSI) and route the data traffic to GlobeTouch GGSN with VF UK IMSI. In case of another Home MNO, whose GGSN/BSS may not support provisioning of another MNO IMSI (VF UK IMSI in this case), the cloudSIM hub 118 translates AirTel IMSI to that network Home IMSI (e.g. AirTel IMSI to AT&T USA IMSI if AT&T is the home network in this example). This scenario allows getting better data roaming rates leveraging some other MNO/servicing provider's data services which controlling authentication/network registration by home network who is the primary connectivity provider for the connected car manufacturer (e.g. Honda).

In accordance with another embodiment of the present invention, cloudSIM hub 118 implements a pure network based solution to segregate and route the traffic to right operator network. The cloudSIM hub 118 leverages the OMACP based device management function in conjunction with cloudSIM applet to detect and notify the SIM device's IMEI. This is helpful in avoiding situations where in smartphones (Andriod or iOS based), automatic configuration of APN happens when IMSI is changed. In such cases the dual or multi-IMSI solutions fail to segregate the network traffic generated by usage from hub operator's subscribers and from local subscribers from the hub operator, whose IMSI is used to avail this service.

In some cases when subscriber uses an Android or iOS or similar smartphone, when IMSI is changed, the APN is also changed. When cloudSIM Applet switches from Home IMSI to any partner IMSI from ecosystem, the APN of partner network is configured. Hence, subscriber cannot use HPMN data services unless client APNs are re-configured or data traffic is re-routed to client network.

To avoid this situation, in accordance with an embodiment of the present invention, during GPRS registration on new IMSI (once cloudSIM applet switches), the cloudSIM hub changes following parameters in MAP ISD message to facilitate data routing through VPMN:
Change the APN-OI Replacement parameter in GPRS Subscription Data
Change APN-OI-Replacement parameter (UE level) in EPS Subscription Data

This feature is supported in most of the latest SGSNs (3GPP Release 8 and later) and hence it is desirable way to handle common APNs cases for VoLTE (using VoLTE default APN).

In LTE case, SIM devices get connected to one or more Packet Data Network (PDN), such as the Internet. The PDN Gateway (P-GW) interconnects LTE to the external PDN. Therefore, as part of the PDN Connectivity process, the SIM device may request an APN, or MME might select a default APN. The MME uses the APN to identify the P-GW that will be selected for connectivity to the PDN of interest. An APN may be presented in the form APN-FQDN (Fully Qualified Domain Name) and is case insensitive. APNs have two main components. APN Network Identifier (APN-NI) which is a mandatory field; while the other component is optional and is called the APN Operator Identifier (APN-OI).

If the APN-OI-Replacement field Attribute Value Pair (AVP) is present in the subscriber profile that is returned by the HSS to the MME in the Update Location Answer (ULA), then the APN-OI field will be replaced by the one provided in the subscriber profile.

Typically, such replacement is done in the case of “non-roaming and home routed roaming” case. An example of APN-OI replacement would be:

Given:
APN-NI: internet-4
APN-OI replacement field: north.mnc111.mcc222.grps

The following will be performed while deriving the APN-FQDN:
“apn.epc” will be placed between the mnc111 and its preceding label.
“.3gppnetwork.org” will replace “.gprs”

The resulting APN-FQDN:
internet-4.north.apn.epc.mnc111.mcc222.3 gppnetwork.org

In accordance with another embodiment of the present invention, for cloudSIM LTE workflow, CloudSIM Hub 118 is in path of Diameter Update Location Answer message and populates the APN-OI replacement AVP with correct value to facilitate routing of data traffic through cloudSIM Hub 118 by VPMN. The cloudSIM Hub 118 also can also add a wildcard APN in place of client network specific APNs.

In case of SIM OTA technology a common technique is to determine that the OTA packet is delivered to SIM card is implementing Proof of Receipt (POR) or Proof of Execution (POE). However, there are limitations in some of the operator networks, especially in SMSC to implement POR/POE which in turn impacts solution old cloudSIM solution relying solely on SIM-OTA function. The cloudSIM hub of the present invention, overcomes this dependency by implementing an independent POR/POE mechanism in cloudSIM hub platform to determine if the OTA packet is delivered correctly to cloudSIM applet in the SIM card of subscriber's device. Once a dynamic IMSI is OTA downloaded to cloudSIM applet, the cloudSIM DIA platform start tracking if there is a registration request from the same dynamic IMSI coming to cloudSIM Hub 118. If there is no registration attempt seen within a configured time, the DIA platform assumes that OTA operation to download new IMSI failed. Then DIA platform re-initiates the OTA download of same dynamic IMSI to cloudSIM applet.

In some cases, the subscriber's IMSI is changed to a default IMSI via the configuration file. The default IMSI is selected from a sequence of IMSIs in preference order or random order, until one IMSI is successfully registered with the visited network. In accordance with an embodiment of the present invention, the configuration file indicates to dynamically obtain an IMSI. In this case, the SIM is first registered with the default IMSI for the roaming location and then the SIM will request an IMSI via a USSD or SMS or other bearer channel (e.g. WiFi, GPRS, LTE etc.) for a dynamically assigned IMSI for the roaming location. The request then comes to the default IMSI hub, which then consults a central worldwide system or a system responsible for the IMSI assignment of the location (corresponding with the home IMSI) for a dynamically assigned IMSI for the roaming location for the subscriber. Thereafter, the IMSI is sent via OTA via USSD, SMS or other bearer channel in response to the IMSI request. The SIM then re-registers with the newly assigned IMSI.

In order to manage the billing, the cloudSIM service is set up a wholesale broker by Globetouch, whose IMSI hub partners' IMSI and rates are resold with markup to client operators (including MNO, MVNO, and MVNE etc.). The subscriber is billed based on rates received from the hub operator of cloudSIM ecosystem. In order to handle billing for TAP and NRTRDE, cloudSIM hub charges a markup for the leg from the roaming partner IMSI to cloudSIM hub IMSI with roaming partner rate. Further for the leg from cloudSIM hub IMSI to client operator with markup from cloudSIM hub.

In accordance with an embodiment of the present invention, cloudSIM hub offer IMSIs with daily usage cap e.g. an IMSI where unlimited data usage is allowed paying a flat rate e.g. USD 5 per day. The cloudSIM workflow accommodates the special handling of these IMSIs in terms of provisioning, usage monitoring and wholesale billing handling thus providing flexibility to the MNOs to offer best tariff plans to attract more subscribers and service usage.

The cloudSIM hub offers seamless integration with MNO network with minimum integration points. This ensures minimum time to market the services for the client MNO. The cloudSIM hub has an integrated SMSC function to deliver OTA SMS payload to applet and also MO SMS trigger from applet about terminal switch (for IMEI change). This minimizes the time of any 3rd party SMSC integration. It also offers a transparent mode OTA API to integrate with 3rd party OTA platform owned by client MNO where cloudSIM hub creates OTA payload and 3rd party OTA platform just to pass-thru that payload encrypted with right OTA key. This minimizes the time for 3rd party OTA integration with cloudSIM application.

In accordance with various other embodiments of the present invention, the cloudSIM hub 118 offers optimal data routing capability to implement:
a) Optimal routing of user data traffic to local GGSN/PGW depending on current location of device
b) Offer superior user experience by ensuring low latency & higher bandwidth
c) Meet any regulatory or commercial requirements to keep user data within national boundaries

Key benefits of this feature are:
Enables local retail offers for Connected Cars
Provides local internet peering for other M2M devices and applications
Superior user performance for connected devices

The cloudSIM offers a seamless and highly effective ways to create and manage services to all members of the cloudSIM ecosystem e.g. MNO clients, enterprise clients, ecosystem partners and the end subscribers. The cloudSIM offers a client portal to offer an easy to use interface to a client MNO create service profile seamlessly by referring the service related information about the cloudSIM service e.g. coverage, tariff, special offers, country specific regulations etc. There is an automated workflow to create the service profile for the clients. The cloudSIM service similarly offers a donor portal for ecosystem partners to create their service profile, an enterprise portal for enterprise clients to create their service profile and a device application for the end subscribers to manage their services in most seamless and effective way.

In accordance with an embodiment of the present invention, the cloudSIM applet stores IMSI and other subscription data (e.g. SMSC Address, Service Provider Name, List of MCC-MNC where the particular IMSI should work) as part of Java Applet buffer so that there is no need to create proprietary Elementary Files separately in USIM file system. The subscription data is fully managed by the cloudSIM applet and any OTA downloads of additional IMSIs are directed to this applet. These enhancements ensure the CloudSIM Applet can be ported to any SIM card compliant to Java Card standards from any SIM card manufacturer supplier with minimum testing effort.

In accordance with various embodiments of the present invention, the SIM card used to implement the cloudSIM service of this patent application, has a standard UICC (with 4G/3G USIM function along with ISIM function in certain cases) but is capable of storing multiple IMSIs of different MNOs or MVNOs. The applet should be able to store multiple IMSIs. The number of IMSIs will depend on the size of SIM card being used but at least 10 IMSIs should be supported. All the IMSIs are possible to update via OTA. The preferred embodiment of the present invention is to store the IMSI slots as part of Java Applet buffer so that there is no need to create proprietary elementary files separately in USIM file system. The IMSIs and related parameters should be fully managed by the STK applet and the backend systems like DIA platform and OTA platform need not to store the image of the IMSI slots (i.e. which IMSI is in which slot and which free slot to update when OTA downloading a new IMSI).

The key functionalities of the applet high level are:
Perform IMSI management
   Receive and interpret location information from ME using standard SIM ToolKit events
   Inform DIA server of location over USSD or MO SMS
   Receive OTA messages and process IMSI updates (add, update, delete IMSI) from DIA server
Perform IMSI selection
   Store multiple IMSIs (preferably within Applet buffer instead of proprietary SIM Elementary Files)
   Stores MCC—IMSI mapping for all IMSIs with Applet to decide which IMSI to be used in which country
   Switch from one IMSI to another IMSI on location change as per workflow and update relevant SIM Elementary Files (e.g. EF IMSI, EF SMSP etc.)
   Issue Refresh to make device select the new IMSI as active IMSI
Subscriber Interactions
   Display text for specific use cases
   SIM ToolKit menu for IMSI switching manually (enabled in test cards only)

In accordance with various embodiments of the present invention, cloudSIM hub 118 implements the IMSI selection logic in following manner:
When the subscriber switches on the device in a roaming location, the STK applet determines the location and requests for new IMSI for current location from the cloudSIM's DIA platform.
The DIA platform allocates a dynamic IMSI depending on subscriber location and OTA downloads the same to applet
The downloaded dynamic IMSI is selected by the applet as active IMSI and same is used for roaming
Once the subscriber moves to another country or comes back in home country, where the downloaded dynamic IMSI is not valid, the dynamic IMSI is deleted from the SIM card. The same dynamic IMSI goes back to pool and can be used for another subscriber after a quarantine period.

However, as in order to implement this lot of communications between applet and DIA server is required, which creates additional network traffic and potential failure points as well as may affect user experience due to additional time to OTA download a new dynamic IMSI every time even if the subscriber is visiting the same country repeatedly.

To overcome the issues mentioned above, the cloudSIM applet of the present invention, stores multiple dynamic IMSIs in the applet buffer without deleting any dynamic IMSI as soon as subscriber moves to a different country in use. So, when the subscriber is back home or the subscriber moves to another country served by a different dynamic IMSI, the previous dynamic IMSI still remains with applet and can be re-used if the subscriber goes back to the same country again in future, hence removing the need of OTA downloading another IMSI from same donor.

In accordance with another embodiment of the present invention, the applet in addition to storing basic subscription information like: IMSI, SMSC address, service provider name and list of MCC-MNC where that IMSI should work, also stores additional information like preferred PLMN lists and forbidden PLMN List which are used for enhanced user experience. The applet also stores access control class and administrative data for correct working of the applet. The applet handles additional information elements needed for more advanced SIM cards like SPDI, Operator Determined PLMN List, PS LOCI and EPS LOCI for seamless functioning for these SIM cards.

The applet traditionally uses SIM STK command PLI to retrieve location information (MCC, MNC of network where the device did last register attempt—successful or failed). But as there are devices in market which don't support PLI command and there are devices which don't implement the PLI command correctly. To ensure that cloudSIM applet works in such devices, additional location detection mechanisms are added e.g. read SIM card EF LOCI which also contains MCC, MNC of network where the device did its last registration attempt. Additional mechanisms like periodic location check are added to ensure the applet functions in certain erroneous condition.

The traditional workflow of cloudSIM applet is to try latching on in a roaming location in a linear way, i.e.
try current IMSI (in EF IMSI of SIM card)
if not successful, try Home IMSI
if not successful, try Global Roaming IMSI

This liner workflow takes more time for device to latch on in countries where there is no bi-lateral roaming agreements of home network before it can initiate request for dynamic IMSI. This approach also makes push based implementation complex due to requirement for roaming probe integration to track registration attempts using Home IMSI.

In enhanced version of cloudSIM applet, it is possible to configure which IMSI to be used to latch on in roaming location if there is no dynamic IMSI available with applet. It can be either Home IMSI or global roaming IMSI. As a result, the device can directly latch on using global roaming IMSI where Home IMSI cannot work due to absence of a bi-lateral agreement. For push based approach, if the device always latches on using global roaming IMSI ensures that CloudSIM Hub is always in path of registration attempt and can act accordingly without a probe integration need. In case, there is a country/network where the device must latch on using Home IMSI (i.e. use Client Operator's bi-lateral agreement), the applet can switch back to Home IMSI based on list of MCC MNC where Home IMSI should be applicable. Alternatively, DIA platform can force the applet to switch to home IMSI by downloading the home IMSI as dynamic IMSI or updating the configuration to make home IMSI as default IMSI for the particular roaming country.

In accordance with various embodiments of the present invention, various configurations are introduced in the cloudSIM applet to achieve optimal user experience, especially in cases when the active dynamic IMSI loses coverage:
HOME_MCC_MNC: value of client operator MCC MNC
NoCoverageFlag: Flag set for dynamic IMSI Registration failure
   ON: if a dynamic IMSI of a MCC cannot get connection for the country after ToggelCounter is crossed in NoCoverageTimer
   OFF: Initial state
NoSwitchIMSIFlag: Whether to switch the IMSI to HOME/Global IMSI or Not if the current IMSI is an applicable dynamic IMSI in roaming country (System level flag)
   ON: Applet will not change IMSI even no coverage due to regulatory reason
   OFF: Applet will change IMSI
NoUSSDFlag: If USSD support is required for IMSI management (System level flag)
   ON: means no USSD request to be sent to DIA for dynamic IMSI
   OFF: means USSD request to be sent to DIA for dynamic IMSI
ToggleTimer: Timer for toggling between IMSI OR activating NoCoverage flag (6 min or 3 min)
NoCoverageTimer: Timer for dynamic IMSI to be successfully latched on
ToggleCounter: Number of toggle done between Home/Global IMSI and Dynamic IMSI

Furthermore, in existing applet implementations, when the applet receives the new dynamic IMSI from DIA using OTA SMS, it writes the dynamic IMSI along with SMSC and SPN to respective SIM card elementary files. But, if the device is busy in a call (which can be frequent as people tends to make calls just after switching on the device once they land in new country) or any other activities (e.g. SIM Toolkit Busy), the Refresh command will fail. As a result the IMSI (and SMSC, SPN) values in SIM card EF may be different from the one with device. This situation will persist till next power on cycle of the device (or any other subsequent Refresh).

In accordance with various embodiments of the present invention, the cloudSIM applet is enhanced to overcome above situation:
The applet sets a poll interval of e.g. 30-60 Seconds so that the applet gets the status from terminal after in poll interval
Once the applet receives the OTA payload with the dynamic IMSI (and other parameters), it doesn't write the content to respective SIM EFs immediately. The applet waits till the poll interval expires.
Once the poll interval has expired, the cloudSIM applet sends PLI Proactive SIM ToolKit command to check if the device is busy.
If the device is busy it initiates the IMSI switch workflow else it starts another poll interval.

In accordance with an embodiment of the present invention, the cloudSIM applet implements a new configuration to control the applet behavior regarding switching to Home IMSI (or Global Roaming IMSI) if the device loses coverage on the active dynamic IMSI for the current location. This feature makes the service compliant to Permanent Roaming Guidelines in certain countries where switch back to home IMSI (or Global Roaming IMSI) is not recommended.

### NoSwitchIMSIFlag

Whether to switch the IMSI to HOME/Global IMSI or Not if the current IMSI is an applicable dynamic IMSI in roaming country (System level flag)

ON: Applet will not change IMSI even no coverage due to regulatory reason

OFF: Applet will change IMSI

When the cloudSIM applet switches from home IMSI to the dynamic IMSI it updates the SIM card Elementary Files with the corresponding values received from DIA platform for that dynamic IMSI. The cloudSIM applet stores the default contents of these EFs in IMSI Slot for the home IMSI and when the applet is back with Home IMSI as active IMSI (in Home Network or roaming using Home IMSI), the default contents of these EFs are re-written by the cloudSIM applet to respective EFs. Some SIM card Elementary Files (e.g. EF HPPLMN Search Period or EF EHPLMN etc.) may get reset to default values when the IMSI gets updated by the applet (e.g. Home IMSI to Dynamic IMSI). As a result, some EF values set specifically for UICC to work in Home Network may be lost. So, it is important to identify such EFs and store the specific values set during personalization against Home IMSI in IMSI Slot and copy the same back to respective Elementary Files when the device is back with Home IMSI as active IMSI (in Home Network or roaming using Home IMSI). A new configuration is provisioned (Switch to Home IMSI on Power on) to control the applet behavior i.e. whether applet should always switch to Home IMSI on every power on.

In accordance with various embodiments of the present invention, the cloudSIM applet is enhanced to support SIM based terminal switch detection. This functionality detects in case the subscriber changes his/her device and store the new IMEI in its database. The IMEI is used to configure cloudSIM service APNs using OMA-CP compliant Device Management Platform to devices which auto-configures APN on IMSI switch.

The workflow to implement above is as follows:
The cloudSIM Applet will store the device IMEI in the applet buffer.
The cloudSIM Applet will subscribe to STK Power On event.
On each device power on, the Applet will get a trigger from device.
Once the trigger is received, the Applet should use the STK Provide Location Information (PLI) command to fetch the IMEI of the device
Then Applet should compare the value with the IMEI value stored in the buffer
   If there is no IMEI in buffer (e.g. new SIM card being used first time), the new IMEI value should be written to buffer
   If the new IMEI value is different from the one in buffer, overwrite the old IMEI value with the new one in buffer
   If the new IMEI value is same as the one in buffer, no action needed and let the old value be there in buffer
If there is a change in IMEI value (case I and II above), the Applet should send a MO SMS with IMSI, Old IMEI and new IMEI value to DIA platform.
The MO SMS can either be sent to SMSC address in SIM card or to a different SMSC Address which is specific to DIA platform. This will be configurable in the applet
DIA platform will received the MO SMS and send a negative Acknowledgement so that Roaming MO SMS is not charged by the VPMN.
DIA platform then updates the IMSI-IMEI mapping data received from Applet in its database
The SIM based Terminal Switch Detection will be configurable in Applet. The workflow will run only if the Applet is configured to run that. The default configuration will be “Disabled”.

Each SIM card contains three standardized files used during location update while roaming. These files are
List of preferred roaming partners
Current registered network
List of forbidden networks

Once the handset is powered on and the current location/network is detected, the SIM Card receives the necessary events from the mobile phone equipment informing the current location of the subscriber. Based on this location, the applet loaded on SIM processes the files provisioned to select the appropriate IMSI and subsequently use that IMSI to register with the appropriate network. In case, the coverage to appropriate network is lost, the file is re-scanned by the applet and the re-selection of appropriate network/IMSI combination is done. However if none of the available network is provisioned to be selected by foreign IMSIs the applet restores the identity to the home IMSI and uses the home IMSI to access the available network.

All throughout the user experience is seamless and non-intrusive. All the operations pertaining to SIM card management, applet download and IMSI management as well as network selection are transparent to the user thus making the entire roaming experience very easy. It will be apparent to a person skilled in the art that all services are available on home number and hence user experience does not change. In addition to this, in selected countries, subject to local regulations, local numbers may be available along with IMSIs which can be used by the end user of the service.

The cloudSIM ecosystem help the cloudSIM client networks to provide services to its outbound roamers across international borders at the costs much lower than incurred during traditional roaming arrangements. This is done by leveraging use of local/regional IMSIs made available through Globetouch's global cloudSIM alliance. The operators are also benefited
To offer a competitive roaming tariff to subscribers
To overcome competition from international SIM card providers
To tap additional revenue from M2M services which are of global nature e.g. Transportation, shipping etc.
To increase outbound roaming footprint for CAMEL, GPRS or 3G.

The cloudSIM ecosystem also helps the cloudSIM hub operators on following parameters:
Get additional inbound traffic from new networks/subscriber base of the client operators who would leverage the attractive service rates offered by the cloudSIM hubs.
Get additional inbound traffic from cost conscious travelers who prefer to use alternate channels of communication.
Tap additional revenue from M2M services which are of global nature e.g. transportation, shipping etc.
Offer additional outbound traffic to their roaming partners and increase volume offered to these partners to leverage on additional discounts

The additional benefits from cloudSIM ecosystem for the cloudSIM hub operators are given below:
One contract with Globetouch to cover inbound roaming traffic globally from its customers globally.
Operational convenience of standard roaming operations usage transfer using tap files. All other operational items would be same as signing up a roaming partner.
No risk of traffic being steered by roaming partners.

It will be apparent to a person skilled in the art, that the present invention can also be applied to Code Division Multiple Access (CDMA)/American National Standards Institute #41D (ANSI-41D), and various other technologies such as, but not limited to, VoIP, WiFi, 3GSM and inter-standard roaming. In one exemplary case, a CDMA outbound roamer travels with an HPMN CDMA handset. In another exemplary case, the CDMA outbound roamer travels with an HPMN GSM SIM and a GSM handset. In yet another exemplary case, GSM outbound roamer travels with an HPMN CDMA RUIM and a CDMA handset. To support these variations, system 100 will have a separate SS7 and network interfaces, corresponding to both the HPMN and VPMN networks. It will also be apparent to a person skilled in the art that these two interfaces in different directions may not have to be the same technologies. Moreover, there could be multiple types of interface in both directions.

An exemplary list of the mapping between GSM MAP and ANSI-41D is described in the table below as a reference.

| GSM MAP | ANSI-41D |
|---|---|
| Location Update/ISD | REGNOT |
| Cancel Location | REGCAN |
| RegisterSS | FEATUREREQUEST |
| InterrogateSS | FEATUREREQUEST |
| SRI-SM | SMSREQ |
| SRI | LOCATION REQUEST |
| ForwardSMS | SMSDPP |
| ReadyForSMS | SMSNOTIFICATION |
| AlertServiceCenter | SMSNOTIFICATION |
| ReportSMSDelivery | SMDPP |
| ProvideRoamingNumber | ROUTING REQUEST |

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

### Other Variations

Provided above for the edification of those of ordinary skill in the art, and not as a limitation on the scope of the invention, are detailed illustrations of a scheme for proactive roaming tests, discoveries of roaming partner services and discoveries of frauds in roaming using simulated roaming traffic. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

APPENDIX

| Acronym | Description |
|---|---|
| 3G | Third generation of mobile |
| ACM | ISUP Address Completion Message |
| ANM | ISUP Answer Message |
| ANSI-41 | American National Standards Institute #41 |
| ATI | Any Time Interrogation |
| BCSM | Basic Call State Model |
| BSC | Base Station Controller |
| BOIC | Barring Outgoing International Calls |
| BOIC-EX- | Barring Outgoing International Calls except to home |
| Home | country |
| CAMEL | Customized Application for Mobile Enhanced Logic |
| CAP | Camel Application Part |
| CB | Call Barring |
| CC | Country Code |
| CDMA | Code Division Multiplexed Access |
| CdPA | Called Party Address |
| CDR | Call Detail Record |
| CF | Call Forwarding |
| CgPA | Calling Party Address |
| CIC | Circuit Identification Code |
| CLI | Calling Line Identification |
| CSD | Circuit Switched Data |
| CSI | Camel Subscription Information |
| DPC | Destination Point Code |
| DSD | Delete Subscriber Data |
| DTMF | Dual Tone Multi-Frequency |
| ERB | CAP Event Report Basic call state model |
| EU | European Union |
| FPMN | Friendly Public Mobile Network |
| FTN | Forward-To-Number |
| GLR | Gateway Location Register |
| GGSN | Gateway GPRS Support Node |
| GMSC | Gateway MSC |
| GMSC-F | GMSC in FPMN |
| GMSC-H | GMSC in HPMN |
| GPRS | General Packet Radio System |
| GSM | Global System for Mobile |
| GSMA | GSM Association |
| GSM SSF | GSM Service Switching Function |
| GsmSCF | GSM Service Control Function |
| GT | Global Title |
| GTP | GPRS Tunnel Protocol |
| HLR | Home Location Register |
| HPMN | Home Public Mobile Network |
| IN | Intelligent Network |
| IOT | Inter-Operator Tariff |
| GTT | Global Title Translation |
| IAM | Initial Address Message |
| IDP | Initial DP IN/CAP message |
| IDD | International Direct Dial |
| IMSI | International Mobile Subscriber Identity |
| IMSI-H | HPMN IMSI |
| IN | Intelligent Network |
| INAP | Intelligent Network Application Part |
| INE | Interrogating Network Entity |
| IP | Internet Protocol |
| IREG | International Roaming Expert Group |
| IRS | International Revenue Share |
| ISC | International Service Carrier |
| ISD | MAP Insert Subscriber Data |
| ISG | International Signal Gateway |
| IST | Immediate Service Termination |
| ISTP | International STP |
| ISTP-F | ISTP connected to FPMN STP |
| ISTP-H | ISTP connected to HPMN STP |
| ISUP | ISDN User Part |
| ITPT | Inbound Test Profile Initiation |
| ITR | Inbound Traffic Redirection |
| IVR | Interactive Voice Response |
| LU | Location Update |
| LUP | MAP Location Update |
| MAP | Mobile Application Part |
| MCC | Mobile Country Code |
| MCC | Mobile Country Code |
| MD | Missing Data |
| ME | Mobile Equipment |
| MGT | Mobile Global Title |
| MMS | Multimedia Message Service |
| MMSC | Multimedia Message Service Center |
| MMSC-F | FPMN MMSC |
| MMSC-H | HPMN MMSC |
| MNC | Mobile Network Code |
| MNP | Mobile Number Portability |
| MO | Mobile Originated |
| MOS | Mean Opinion Score |
| MS | Mobile Station |
| MSC | Mobile Switching Center |
| MSISDN | Mobile Station International Subscriber Directory Number |
| MSISDN-F | FPMN MSISDN |
| MSISDN-H | HPMN MSISDN |
| MSRN | Mobile Station Roaming Number |
| MSRN-F | FPMN MSRN |
| MSRN-H | HPMN MSRN |
| MT | Mobile Terminated |
| MTP | Message Transfer Part |
| NDC | National Dialing Code |
| NP | Numbering Plan |
| NPI | Numbering Plan Indicator |
| NRTRDE | Near Real Time Roaming Data Exchange |
| O-CSI | Originating CAMEL Subscription Information |
| OCN | Original Called Number |
| ODB | Operator Determined Barring |
| OPC | Origination Point Code |
| OR | Optimal Routing |
| ORLCF | Optimal Routing for Late Call Forwarding |
| OTA | Over The Air |
| OTPI | Outbound Test Profile Initiation |
| PDP | Protocol Data Packet |
| PDN | Packet Data Network |
| PDU | Packet Data Unit |
| PRN | MAP Provide Roaming Number |
| PSI | MAP Provide Subscriber Information |
| QoS | Quality of Service |
| RAEX | Roaming Agreement EXchange |
| RI | Routing Indicator |
| RIS | Roaming Intelligence System |
| RDN | Redirecting Number |
| RNA | Roaming Not Allowed |
| RR | Roaming Restricted due to unsupported feature |
| RRB | CAP Request Report Basic call state model |
| RSD | Restore Data |
| RTP | Real-Time Transport Protocol |
| SAI | Send Authentication Info |
| SC | Short Code |
| SCA | Smart Call Assistant |
| SCCP | Signal Connection Control part |
| SCP | Signaling Control Point |
| SF | System Failure |
| SG | Signaling Gateway |
| SGSN | Serving GPRS Support Node |
| SGSN-F | FPMN SGSN |
| SIM | Subscriber Identity Module |
| SIGTRAN | Signaling Transport Protocol |
| SME | Short Message Entity |
| SM-RP-UI | Short Message Relay Protocol User Information |
| SMS | Short Message Service |
| SMSC | Short Message Service Center |
| SMSC-F | FPMN SMSC |
| SMSC-H | HPMN SMSC |
| SoR | Steering of Roaming |
| SPC | Signal Point Code |
| SRI | MAP Send Routing Information |
| SRI-SM | MAP Send Routing Information For Short Message |
| SS | Supplementary Services |
| SS7 | Signaling System #7 |
| SSN | Sub System Number |
| SSP | Service Switch Point |
| STK | SIM Tool Kit Application |
| STP | Signal Transfer Point |
| STP-F | FPMN STP |
| STP-H | HPMN STP |
| TADIG | Transferred Account Data Interchange Group |
| TAP | Transferred Account Procedure |
| TCAP | Transaction Capabilities Application Part |
| VT-CSI | Visited Terminating CAMEL Service Information |
| TP | SMS Transport Protocol |
| TR | Traffic Redirection |
| TS | Traffic Steering |
| TE | Termination Ecosystem |
| TT | Translation Type |
| UD | User Data |
| UDH | User Data Header |
| UDHI | User Data Header Indicator |
| USSD | Unstructured Supplementary Service Data |
| VAS | Value Added Service |
| VIP | Very Important Person |
| VLR | Visited Location Register |
| VLR-F | FPMN VLR |
| VLR-H | HPMN VLR |
| VLR-V | VPMN VLR |
| VMSC | Visited Mobile Switching Center |
| VoIP | Voice over IP |
| VPMN | Visited Public Mobile Network |
| ATI | Access Transport Information |
| UDV | Unexpected Data Value |
| USI | User Service Information |
| WAP | Wireless Access Protocol |

I claim:

1. A method for mobile communication, the method comprising:
detecting change in registration of a SIM device at a visited operator (VPMN);
allocating dynamic IMSI with either a partial IMSI profile or a full IMSI profile based on SIM device requirement; wherein a full profile has security key information of a HPMN or the VPMN; and the SIM device requirement can be from one of a softSIM or an eSIM or a standard SIM associated with cloudSIM hub; and
switching from the SIM device's IMSI profile to one of a HPMN IMSI profile or local IMSI profile of a hub operator, wherein the hub operator is selected from a cloudSIM hub ecosystem depending on the location of the SIM device and quality and regulatory requirements of the service associated with the SIM device.

2. The method of claim 1, wherein cloudSIM hub uses SIM Toolkit Applet (STK) in a standard SIM card along with OTA function to handle dynamic IMSI.

3. The method of claim 1, wherein dynamic IMSI allocation is done by cloudSIM DIA (Dynamic IMSI Allocation) platform.

4. The method of claim 1, wherein dynamic IMSI allocation works in one of a pull mode or push mode.

5. The method of claim 4, wherein in the pull mode, cloudSIM Applet provides the cloudSIM DIA information for subscriber location and device.

6. The method of claim 4, wherein in the push mode, cloudSIM DIA gets subscriber's location and device information via a roaming probe.

7. The method of claim 1, wherein dynamic IMSI allocation includes allocating one of a local IMSI, a permanent roaming IMSI or a temporary roaming IMSI.

8. The method of claim 1, wherein selection of hub operator is based on one or more criteria like wholesale tariff agreed in visited country, type of subscriber, devices being services, pre-paid or postpaid plan, full service or data service only, or cost or QoS ranking of network in visited country.

9. The method of claim 1, wherein dynamic IMSI allocation is performed using cloudSIM applet to detect and notify IMEI of device for OMACP based devices.

10. The method of claim 1, wherein dynamic IMSI allocation is performed using independent POR/POE mechanism to determine if OTA packet is delivered correctly to cloudSIM applet in SIM.

11. The method of claim 1, wherein cloudSIM implements multi-hub architecture where regional hubs are used to connect to different clients participating in the ecosystem.

12. The method of claim 1, wherein when dynamic IMSI full profile is based on the VPMN, then cloudSIM hub maintains billing and provisioning interface with the VPMN.

13. The method of claim 1, wherein when dynamic IMSI partial profile has only IMSI based on the VPMN, then cloudSIM hub handles signaling and data routing within cloudSIM ecosystem to configure the mapping of IMSI to another HPMN IMSI and redirect data to corresponding data gateway of HPMN.

14. The method of claim 1, wherein when dynamic IMSI partial profile has IMSI and Ki based on local VPMN but APN points to cloudSIM hub, then cloudSIM hub relays the signaling to the VPMN and data routing through cloudSIM ecosystem to a mapped IMSI of HPMN gateway.

15. The method of claim 1, wherein when dynamic IMSI partial profile has IMSI based on local VPMN, Ki pointing to HPMN IMSI and APN pointing to cloudSIM hub and data routing to another HPMN operator, then cloudSIM hub maintains the signaling via home IMSI of HPMN, and data service to the data gateways of another HPMN.

16. The method of claim 1, wherein the cloudSIM hub converts one or more signaling parameters of signaling associated with the hub operator's IMSI to one or more signaling parameters of the signaling associated with the SIM device's IMSI.

17. The method of claim 1, wherein one or more signaling parameters comprises of MAP signaling, call signaling, subscriber's MSISDN, CAMEL/SIP/TCAP transaction, data sessions and data traffic.

18. The method of claim 1, wherein the hub operator is one of an MVNO, an MNO, having its own set of IMSIs.

19. The method of claim 1, wherein the cloud SIM hub is located either on-net the hub operator or off-net the hub operator.

20. The method of claim 1, wherein the change in SIM device's IMSI is based on at least one of a roaming location of the subscriber, class of the subscriber and a predefined logic.

21. The method of claim 1, wherein the SIM device's IMSI is changed via a configuration file that can be changed by OTA.

22. The method of claim 1, wherein the SIM device's IMSI is changed to a default IMSI via a configuration file.

23. The method of claim 22, wherein the default IMSI is selected from a sequence of IMSIs in preference order or random order, until one IMSI is successfully registered with the visited network.

24. The method of claim 1, wherein the subscriber's IMSI is changed by SIM STK application that communicates with network application via one of USSD, SMS and other bearer.

25. The method of claim 1, wherein the subscriber is billed based on rates from the hub operator.

26. The method of claim 1, wherein cloudSIM stores IMSI and other subscription data in applet buffer.

27. A system for mobile communication, the system comprising:
a CloudSIM hub ecosystem associated with a plurality of hub operators, wherein a SIM device registers with a visited operator (VPMN);
a cloudSIM hub associated with a hub operator, dynamic IMSI with either a partial IMSI profile or a full IMSI profile based on SIM device requirement; wherein a full profile has security key information of a HPMN or the VPMN; and the SIM device requirement can be from one of a softSIM or an eSIM or a standard SIM associated with cloudSIM hub; and
the cloudSIM hub switches from the SIM device's IMSI profile to one of a HPMN IMSI profile or local IMSI profile of a hub operator, wherein the hub operator is selected from a cloudSIM hub ecosystem depending on the location of the SIM device and quality and regulatory requirements of the service associated with the SIM device.

28. The system of claim 27, wherein cloudSIM hub uses Sim Toolkit Applet in a standard SIM card along with OTA function to handle dynamic IMSI.

29. The system of claim 27, wherein cloudSIM hub allocates dynamic IMSI allocation using cloudSIM DIA (Dynamic IMSI Allocation) platform.

30. The system of claim 27, wherein cloudSIM hub allocates dynamic IMSI allocation using one of a pull mode or push mode.

31. The system of claim 30, wherein in the pull mode, cloudSIM Applet provides the cloudSIM DIA information for subscriber location and device.

32. The system of claim 30, wherein in the push mode, cloudSIM DIA gets subscriber's location and device information via a roaming probe.

33. The system of claim 27, wherein the cloudSIM hub allocates dynamic IMSI that is one of a local IMSI, a permanent roaming IMSI or a temporary roaming IMSI.

34. The system of claim 27, wherein the cloudSIM hub selects hub operator based on one or more criteria like wholesale tariff agreed in visited country, type of subscriber, devices being services, pre-paid or postpaid plan, full service or data service only, or cost or QoS ranking of network in visited country.

35. The system of claim 27, wherein the cloudSIM hub allocates dynamic IMSI using cloudSIM applet to detect and notify IMEI of device for OMACP based devices.

36. The system of claim 27, wherein the cloudSIM hub allocates dynamic IMSI using independent POR/POE mechanism to determine if OTA packet is delivered correctly to cloudSIM applet in SIM.

37. The system of claim 27, wherein the cloudSIM hub implements multi-hub architecture where regional hubs are used to connect to different clients participating in the ecosystem.

38. The system of claim 27, wherein the cloudSIM hub maintains billing and provisioning interface with the VPMN, when dynamic IMSI full profile is based on the VPMN.

39. The system of claim 27, wherein the cloudSIM hub handles signaling and data routing within cloudSIM ecosystem to configure the mapping of IMSI to another HPMN IMSI and redirect data to corresponding data gateway of HPMN, when dynamic IMSI partial profile has only IMSI based on the VPMN.

40. The system of claim 27, wherein the cloudSIM hub relays the signaling to the VPMN and data routing through cloudSIM ecosystem to a mapped IMSI of HPMN gateway when dynamic IMSI partial profile has IMSI and Ki based on local VPMN but APN points to cloudSIM hub.

41. The system of claim 27, wherein the cloudSIM hub maintains the signaling via home IMSI of HPMN, and data service to the data gateways of another HPMN, when dynamic IMSI partial profile has IMSI based on local VPMN, Ki pointing to HPMN IMSI and APN pointing to cloudSIM hub and data routing to another HPMN operator.

42. The system of claim 27, wherein the cloud SIM hub converts one or more signaling parameters of signaling associated with the hub operator's IMSI to one or more signaling parameters of the signaling associated with the client operator's IMSI.

43. The system of claim 27, wherein the one or more signaling parameters comprises of MAP signaling, call signaling, subscriber's MSISDN, CAMEL/SIP/TCAP transaction, data sessions and data traffic.

44. The system of claim 27, wherein the hub operator is one of an MVNO, an MNO having its own set of IMSIs.

45. The system of claim 27, wherein the cloudSIM hub is located either on-net the hub operator or off-net the hub operator.

46. The system of claim 27, wherein the change in subscriber's IMSI is based on at least one of a roaming location of the subscriber, class of the subscriber and a predefined logic.

47. The system of claim 27, wherein the subscriber's IMSI is changed via a configuration file that can be changed by OTA.

48. The system of claim 27, wherein the subscriber's IMSI is changed to a default IMSI via a configuration file.

49. The system of claim 48, wherein the default IMSI is selected from a sequence of IMSIs in preference order or random order, until one IMSI is successfully registered with the visited network.

50. The system of claim 27, wherein the subscriber's IMSI is changed by SIM STK application that communicates with network application via one of USSD, SMS and other bearer.

51. The system of claim 27, wherein the subscriber is billed based on rates from the hub operator.
The system of claim 27, wherein cloudSIM stores IMSI and other subscription data in applet buffer.
